(19) United States
(12) Patent Application Publication
(10) Pub. No.: US 2025/0274914 A1
(43) Pub. Date: Aug. 28, 2025

(54) RESOURCE INDICATION METHOD AND COMMUNICATION APPARATUS

(71) Applicant: HUAWEI TECHNOLOGIES CO., LTD., Shenzhen (CN)

(72) Inventor: Zhongfeng LI, Shanghai (CN)

(21) Appl. No.: 19/195,286

(22) Filed: Apr. 30, 2025

Related U.S. Application Data
(63) Continuation of application No. PCT/CN2022/130077, filed on Nov. 4, 2022.

(51) Int. Cl. H04W 72/0446; H04W 72/25; H04W 88/04

(52) U.S. Cl. CPC H04W 72/0446; H04W 72/25; H04W 88/04

(57) ABSTRACT

This application provides a resource indication method and a communication apparatus. The method is applied to the field of communication technologies. The method includes: obtaining indication information that indicates a configuration of time-domain resources for M-hop transmission between a first apparatus and a target apparatus, where the M-hop transmission includes a transmission between the first apparatus and a second apparatus, the indication information includes first information indicating a configuration of at least two time-domain resources that belong to a time-domain transmission resource and/or a time-domain reserved resource for the M-hop transmission, and M is an integer greater than 1; and sending the indication information to the second apparatus. The method described in this application can reduce time-domain resource indication overheads.

### CROSS-REFERENCE TO RELATED APPLICATIONS

This application is a continuation of International Application No. PCT/CN2022/130077, filed on Nov. 4, 2022, the disclosure of which is hereby incorporated by reference in its entirety.

### TECHNICAL FIELD

This application relates to the field of communication technologies, and in particular, to a resource indication method and a communication apparatus.

### BACKGROUND

With large-scale popularization of Internet applications and wireless network devices, people's requirements for wireless communication gradually increase. To improve communication coverage, a relay apparatus is introduced at present to support multi-hop transmission from a source apparatus to a target apparatus. Three-hop transmission is used as an example. A source apparatus needs to send data to a target apparatus through two relay apparatuses, which are referred to as a first relay apparatus and a second relay apparatus. The source apparatus sends the data to the first relay apparatus, the first relay apparatus forwards the data to the second relay apparatus after receiving the data, and the second relay apparatus forwards the data to the target apparatus after receiving the data.

However, when the relay apparatus forwards the data, a time-domain resource corresponding to each hop is separately indicated, causing high overheads. How to reduce overheads is an urgent problem to be resolved.

### SUMMARY

This application provides a resource indication method and a communication apparatus. The method described in this application can reduce time-domain resource indication overheads.

According to a first aspect, this application provides a resource indication method. The method includes: obtaining indication information, where the indication information indicates a configuration of time-domain resources for M-hop transmission between a first apparatus and a target apparatus, the M-hop transmission includes transmission between the first apparatus and a second apparatus, the indication information includes first information, the first information indicates a configuration of at least two time-domain resources, the at least two time-domain resources belong to a time-domain transmission resource and/or a time-domain reserved resource for the M-hop transmission, and M is an integer greater than 1; and sending the indication information to the second apparatus.

According to a second aspect, this application provides a resource indication method. The method includes: receiving indication information from a first apparatus, where the indication information indicates a configuration of time-domain resources for M-hop transmission between the first apparatus and a target apparatus, the M-hop transmission includes transmission between the first apparatus and a second apparatus, the indication information includes first information, the first information indicates a configuration of at least two time-domain resources, the at least two time-domain resources belong to a time-domain transmission resource and/or a time-domain reserved resource for the M-hop transmission, and M is an integer greater than 1; and receiving data from the first apparatus based on the indication information.

Resource indication information indicates different time-domain configurations by using different state values, and the state value may be understood as bit information included in the resource indication information. For example, it is assumed that a size configured for the resource indication information is 2 bits. In this case, a state value in the resource indication information may be one of the following four pieces of bit information: 00, 01, 10, and 11. A quantity of state values corresponding to the resource indication information is determined based on a size of the resource indication information. For example, if the size of the resource indication information is 4 bits, the size corresponds to 16 state values, and the resource indication information can indicate a maximum of 16 configuration manners; or if the size of the resource indication information is 2 bits, the size corresponds to four state values, and the resource indication information can indicate a maximum of four configuration manners.

In an embodiment, that is, in a manner in which one piece of resource indication information indicates a configuration of one time-domain resource, a quantity of state values corresponding to a size configured for the resource indication information is greater than a quantity of configuration manners of the time-domain resource. For example, the size of the resource indication information is 2 bits, and corresponds to four state values. The resource indication information can indicate a maximum of four configuration manners. However, a current quantity of configuration manners of the time-domain resource is 3. Because 3 is less than 4, the quantity of state values corresponding to the size configured for the resource indication information is greater than the quantity of configuration manners of the time-domain resource. In addition, as a quantity of time-domain resources that need to be configured increases, higher overheads are caused, and a waste of resources is caused. According to the method described in this application, because the first information indicates the configuration of the at least two time-domain resources, a quantity of state values required by the first information may be determined based on a quantity of configuration manners of the at least two time-domain resources. One state value corresponds to one configuration manner of the at least two time-domain resources. A more appropriate size is configured for the first information based on the quantity of state values required by the first information, to avoid higher overheads caused by a larger quantity of time-domain resources that need to be configured. Therefore, this can effectively reduce a waste of resources caused when a quantity of state values corresponding to a size configured for the first information is greater than a quantity of configurations of a plurality of time-domain resources, thereby effectively reducing time-domain resource indication overheads.

With reference to the method according to the first aspect and the second aspect, in an embodiment, time-domain resources corresponding to the configuration of the at least two time-domain resources do not overlap. In a process of the M-hop transmission, a time-domain transmission resource and a time-domain reserved resource that are required for each hop need to be first determined. In each hop, a time corresponding to the time-domain transmission resource is earlier than a time corresponding to the time-domain reserved resource. In this case, there may be, for example, a situation in which a time-domain reserved resource for a 1^{st} hop overlaps a time-domain transmission resource for a 3^{rd} hop, causing ambiguous indication by the first information.

This embodiment can avoid a problem of ambiguous indication caused by overlapped indication of a time-domain transmission resource and a time-domain reserved resource for different hops.

With reference to the method according to the first aspect and the second aspect, in an embodiment, the indication information further includes second information, the second information indicates a configuration of at least two time-domain resources, the first information indicates a configuration of a first group of time-domain resources, and the second information indicates a configuration of a second group of time-domain resources.

According to an embodiment, both the first information and the second information may indicate a configuration of a plurality of time-domain resources, to improve resource utilization.

With reference to the method according to the first aspect and the second aspect, in an embodiment, the first information and the second information are carried on different channels. In an embodiment, the first information is carried on a control channel, and the second information is carried on a data channel.

According to this implementation, the shared control channel may be obtained by another surrounding apparatus, and the first information is carried on the control channel, so that the configuration, of the time-domain resources, indicated by the first information can be read by the surrounding apparatus. This helps prevent, in a contention-based resource allocation scenario, the other surrounding apparatus from occupying time-domain resources required for the M-hop transmission. In addition, the second information is transmitted on the data channel, so that resources on the control channel can be saved.

With reference to the method according to the first aspect and the second aspect, in an embodiment, the configuration of the first group of time-domain resources includes a configuration of a time-domain transmission resource and a configuration of a time-domain reserved resource between the first apparatus and the second apparatus; and the configuration of the second group of time-domain resources includes a configuration of a time-domain transmission resource and a configuration of a time-domain reserved resource for N-hop transmission, the N-hop transmission is N-hop transmission other than the transmission between the first apparatus and the second apparatus in the M-hop transmission, N is an integer greater than 1, and N is less than M.

According to this embodiment, with reference to the foregoing implementation in which the first information and the second information are carried on different channels, when the first information is carried on a control channel and the second information is carried on a data channel, a time of the first group of time-domain resources is earlier when time-domain resources that are required for 1^{st}-hop transmission and that correspond to the configuration of the first group of time-domain resources are compared with time-domain resources that are required for remaining-hop transmission and that correspond to the configuration of the second group of time-domain resources, and the shared control channel is used for transmission, so that a neighboring apparatus in a current hop can perform reading in time. This helps prevent the neighboring apparatus from occupying a corresponding resource. In an embodiment, the neighboring apparatus in the current hop may be understood as an apparatus that is close to the first apparatus and the second apparatus and that contends for resources with the first apparatus and the second apparatus. In addition, a relative time of the second group of time-domain resources indicated in the second information is later, and the neighboring apparatus in the current hop temporarily does not occupy a corresponding resource. The second information is transmitted on the data channel, so that resources on the control channel can be saved.

With reference to the method according to the first aspect and the second aspect, in an embodiment, the indication information further includes third information, the third information indicates a configuration of at least two time-domain resources, and the third information indicates a configuration of a third group of time-domain resources; the configuration of the first group of time-domain resources includes a configuration of a time-domain transmission resource and a configuration of a time-domain reserved resource between the first apparatus and the second apparatus; the configuration of the second group of time-domain resources includes a configuration of a time-domain transmission resource for (M−1)-hop transmission, and the (M−1)-hop transmission is (M−1)-hop transmission other than the transmission between the first apparatus and the second apparatus in the M-hop transmission; and the configuration of the third group of time-domain resources includes a configuration of a time-domain reserved resource for the (M−1)-hop transmission.

According to this embodiment, with reference to the foregoing implementation in which the first information and the second information are carried on different channels, when the first information is carried on a control channel, the second information is carried on a data channel, and the third information is carried on a data channel, a time of the first group of time-domain resources is earlier when a configuration that is of a time-domain transmission resource for the M-hop transmission and that corresponds to the configuration of the first group of time-domain resources is compared with configurations of the other two groups of time-domain resources, and the shared control channel is used, so that a surrounding and neighboring apparatus can perform reading in time. This helps prevent the surrounding and neighboring apparatus in a current hop from occupying a corresponding resource. In addition, relative times of the second group of time-domain resources indicated in the second information and the third group of time-domain resources indicated in the third information are later, and the neighboring apparatus temporarily does not occupy a corresponding resource. The second information and the third information are transmitted on the data channel, so that resources on the control channel can be saved. Alternatively, when both the first information and the second information are carried on a control channel and the third information is carried on a data channel, times of the first group of time-domain resources and the second group of time-domain resources are earlier, and the shared control channel is used, so that a surrounding and neighboring apparatus in a current hop can perform reading in time. This helps prevent the surrounding and neighboring apparatus in the current hop from occupying a corresponding resource. In addition, a relative time of the third group of time-domain resources indicated in the third information is later, and the neighboring apparatus in the current hop temporarily does not occupy a corresponding resource. The third information is transmitted on the data channel, so that resources on the control channel can be saved. Because transmission resources required for hops in multi-hop transmission are arranged in sequence, no overlap occurs. Similarly, reserved resources required for the hops in the multi-hop transmission are arranged in sequence, and no overlap occurs. The configuration of the second group of time-domain resources includes the configuration of the time-domain transmission resource for the (M−1)-hop transmission, and the configuration of the third group of time-domain resources includes the configuration of the time-domain reserved resource for the (M−1)-hop transmission, so that time-domain resources in a same group do not overlap each other. Therefore, the configuration of the second group of time-domain resources and the configuration of the third group of time-domain resources have no problem of ambiguous indication. In addition, in an embodiment, because a time-domain resource corresponding to the configuration of the second group of time-domain resources and a time-domain resource corresponding to the configuration of the third group of time-domain resources are indicated by using different information, time-domain resources in the two groups may overlap, to improve resource utilization.

With reference to the method according to the first aspect and the second aspect, in an embodiment, the configuration of the first group of time-domain resources includes a configuration of a time-domain transmission resource for the M-hop transmission, and the configuration of the second group of time-domain resources includes a configuration of a time-domain reserved resource for the M-hop transmission.

According to this embodiment, with reference to the foregoing implementation in which the first information and the second information are carried on different channels, when the first information is carried on a control channel and the second information is carried on a data channel, a time of the first group of time-domain resources is earlier when the configuration that is of the time-domain transmission resource for the M-hop transmission and that corresponds to the configuration of the first group of time-domain resources is compared with the configuration that is of the time-domain reserved resource for the M-hop transmission and that corresponds to the configuration of the second group of time-domain resources, and the shared control channel is used for transmission, so that a surrounding and neighboring apparatus in a current hop can perform reading in time. This helps prevent the surrounding and neighboring apparatus in the current hop from occupying a corresponding resource. In addition, a relative time of the second group of time-domain resources indicated in the second information is later, and the neighboring apparatus temporarily does not occupy a corresponding resource. The second information is transmitted on the data channel, so that resources on the control channel can be saved.

With reference to the method according to the first aspect and the second aspect, in an embodiment, the indication information includes M pieces of first information, and the first information indicates a configuration of a time-domain transmission resource and a configuration of a time-domain reserved resource for one-hop transmission in the M-hop transmission.

According to this embodiment, in the M pieces of first information, first information indicating a configuration of a time-domain transmission resource and a configuration of a time-domain reserved resource for a 1^{st} hop may be carried on a control channel, and M−1 pieces of first information other than the first information indicating the configuration of the time-domain transmission resource and the configuration of the time-domain reserved resource for the 1^{st} hop in the M pieces of first information are carried on a data channel. A relative time of time-domain resources required for the 1^{st} hop is earlier, and the shared control channel is used, so that a surrounding and neighboring apparatus in a current hop can perform reading in time. This helps prevent the surrounding and neighboring apparatus in the current hop from occupying a corresponding resource. In addition, time-domain resources indicated in the other M−1 pieces of first information are later. Therefore, the neighboring apparatus temporarily does not occupy a corresponding resource. Transmission is performed on the data channel, so that resources on the control channel can be saved.

With reference to the method according to the first aspect and the second aspect, in an embodiment, the indication information further includes fourth information, and the fourth information indicates a configuration of one time-domain resource.

In an embodiment, the fourth information includes a plurality of state values, and one state value corresponds to one configuration of the time-domain resource. Correspondingly, the fourth information indicates the time-domain resource in a separate indication manner. In an embodiment, the fourth information indicates a time-domain transmission resource between the first apparatus and the second apparatus. Further, in an embodiment, the fourth information may be carried on a control channel for transmission. The separate indication method is used, so that a surrounding and neighboring apparatus in a current hop can read the fourth information more quickly when obtaining the information, to reduce an operation burden, and prevent the neighboring apparatus from occupying the time-domain transmission resource required for the transmission between the first apparatus and the second apparatus.

According to a third aspect, this application provides a communication apparatus. The communication apparatus may alternatively be a chip system. The communication apparatus may perform the method according to the first aspect. A function of the communication apparatus may be implemented by hardware, or may be implemented by hardware executing corresponding software. The hardware or the software includes one or more units or modules corresponding to the foregoing function. The unit or the module may be software and/or hardware. For operations performed by the communication apparatus and beneficial effects thereof, refer to the method according to the first aspect and the beneficial effects thereof. Repeated parts are not described again.

According to a fourth aspect, this application provides a communication apparatus. The communication apparatus may alternatively be a chip system. The communication apparatus may perform the method according to the second aspect. A function of the communication apparatus may be implemented by hardware, or may be implemented by hardware executing corresponding software. The hardware or the software includes one or more units or modules corresponding to the foregoing function. The unit or the module may be software and/or hardware. For operations performed by the communication apparatus and beneficial effects thereof, refer to the method according to the second aspect and the beneficial effects thereof. Repeated parts are not described again.

According to a fifth aspect, this application provides a communication apparatus. The communication apparatus includes a processor, and when the processor invokes a computer program in a memory, the method according to the first aspect or the second aspect is performed.

In an embodiment, the communication apparatus further includes the memory, and the memory and the processor are coupled to each other. In an embodiment, the memory and the processor are integrated together.

In an embodiment, the communication apparatus further includes a transceiver, and the transceiver is configured to send and receive data and/or signaling.

According to a sixth aspect, this application provides a communication apparatus. The communication apparatus includes a processor and an interface circuit. The interface circuit is configured to: receive a signal from a communication apparatus other than the communication apparatus and transmit the signal to the processor, or send a signal from the processor to a communication apparatus other than the communication apparatus. The processor is configured to implement the method according to the first aspect or the second aspect by using a logic circuit or by executing code instructions.

According to a seventh aspect, this application provides a computer-readable storage medium. The storage medium stores a computer program or instructions. When the computer program or the instructions are executed by a communication apparatus, the method according to the first aspect or the second aspect is implemented.

According to an eighth aspect, an embodiment of this application provides a computer program or a computer program product, including code or instructions. When the code or the instructions are run on a computer, the computer is enabled to perform the method according to the first aspect or the second aspect.

According to a ninth aspect, an embodiment of this application provides a communication system. The system includes the communication apparatuses provided in the third aspect and the fourth aspect.

### BRIEF DESCRIPTION OF DRAWINGS

FIG. 1 is a diagram of an architecture of a communication system according to an embodiment of this application;

FIG. 2 is a diagram of three-hop transmission according to an embodiment of this application;

FIG. 3 is a schematic flowchart of a resource indication method according to an embodiment of this application;

FIG. 4 is a diagram of time-domain resource indication according to an embodiment of this application;

FIG. 5 is a diagram of three-hop transmission according to an embodiment of this application;

FIG. 6 is a diagram of a structure of a communication apparatus according to an embodiment of this application;

FIG. 7 is a diagram of a structure of another communication apparatus according to an embodiment of this application;

FIG. 8 is a diagram of a structure of another communication apparatus according to an embodiment of this application; and

FIG. 9 is a diagram of a structure of a chip according to an embodiment of this application.

### DETAILED DESCRIPTION

The following further describes specific embodiments of this application in detail with reference to accompanying drawings.

The terms “first”, “second”, and the like in the specification, claims, and accompanying drawings of this application are intended to distinguish between different objects, but are not intended to describe a specific sequence. In addition, the terms “include” and “have” and any other variants thereof are intended to cover a non-exclusive inclusion. For example, a process, a method, a system, a product, or a device that includes a series of operations or units is not limited to the listed operations or units, but may further include an unlisted operation or unit, or may further include another operation or unit of the process, the method, the product, or the device.

An “embodiment” mentioned in the specification indicates that a particular feature, structure, or characteristic described with reference to this embodiment may be included in at least one embodiment of this application. The word shown in various locations in the specification may not necessarily refer to a same embodiment, and is not an independent or optional embodiment exclusive from another embodiment. It is explicitly and implicitly understood by a person skilled in the art that embodiments described in the specification may be combined with another embodiment.

In this application, “at least one (item)” means one or more, “a plurality of” means two or more, “at least two (items)” means two, three, or more, and “and/or” is used to describe a correspondence between associated objects and indicates that three relationships may exist. For example, “A and/or B” may indicate the following three cases: Only A exists, only B exists, and both A and B exist, where A and B may be singular or plural. The character “/” generally indicates an “or” relationship between the associated objects. “At least one of the following items (pieces)” or a similar expression thereof means any combination of these items, including a single item (piece) or any combination of a plurality of items (pieces). For example, at least one of a, b, or c may indicate a, b, c, “a and b”, “a and c”, “b and c”, or “a, b, and c”, where a, b, and c may be singular or plural.

The following describes a system architecture in embodiments of this application.

For ease of understanding technical solutions in embodiments of this application, the following briefly describes a system architecture for a method provided in embodiments of this application. It may be understood that the system architecture described in embodiments of this application is intended to describe the technical solutions in embodiments of this application more clearly, and does not constitute a limitation on the technical solutions provided in embodiments of this application.

The technical solutions in embodiments of this application may be applied to various communication systems, for example, a wireless local area network (WLAN) communication system, a wireless fidelity (Wi-Fi) system, a long term evolution (LTE) system, an LTE frequency division duplex (FDD) system, LTE time division duplex (TDD), a 5th generation (5G) system or new radio (NR), an evolved communication system after 5G such as a 6th generation (6G) system, another future communication system, and the like, and further supports a communication system that integrates a plurality of wireless technologies, for example, may be further applied to a system that integrates a non-terrestrial network (NTN) and a terrestrial mobile communication network, such as an unmanned aerial vehicle, a satellite communication system, or high-altitude platform station (HAPS) communication.

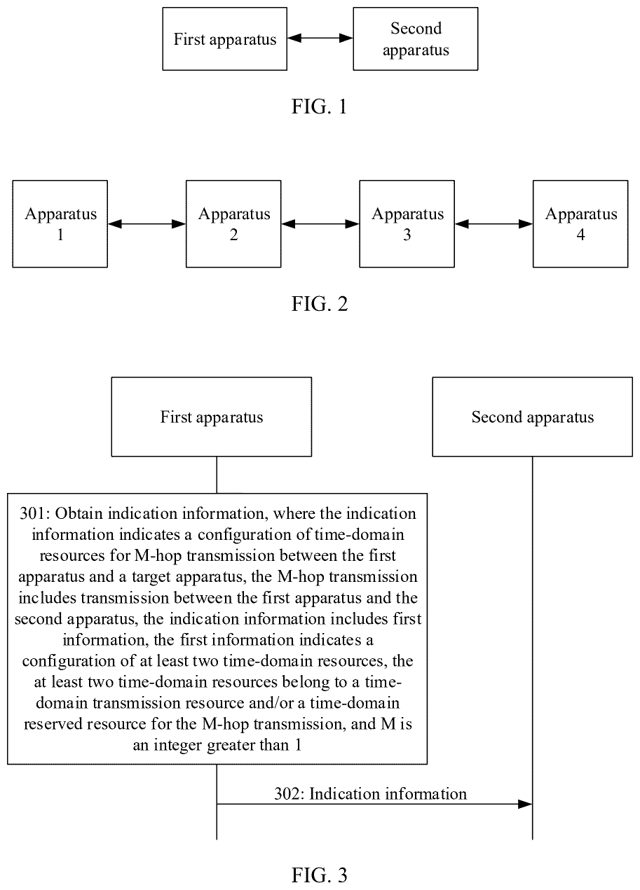

FIG. 1 is a diagram of a communication system applicable to an embodiment of this application. The communication system includes at least one first apparatus and at least one second apparatus. In FIG. 1, one first apparatus and one second apparatus are used as an example. A quantity of first apparatuses and a quantity of second apparatuses are not limited in embodiments of this application. The first apparatus and the second apparatus can communicate with each other. In addition, the first apparatus and the second apparatus may further establish a communication connection to another apparatus or device.

In an embodiment, the first apparatus and/or the second apparatus may be a network device or an apparatus that implements a function of a network device, or may be an apparatus that can support a network device in implementing the function, for example, a chip system, and the apparatus may be installed in the network device. The network device mentioned in this embodiment of this application may be a device configured to communicate with a terminal device, or may be a device that connects a terminal device to a wireless network. The network device may be a node in a radio access network, and may also be referred to as a base station, or may be referred to as a radio access network (RAN) node (or device). For example, the base station in this embodiment of this application may include various forms of base stations, for example, a macro base station, a micro base station (also referred to as a small cell), a relay node, an access point, an evolved NodeB (eNB or eNodeB) in LTE, a gNodeB (gNB) in a 5G network, a broadband network gateway (BNG), an aggregation switch or a non-3rd generation partnership project (3GPP) access device, a transmitting and receiving point (TRP), a transmitting point (TP), a mobile switching center, a home base station (for example, a home evolved NodeB or a HNB), a baseband unit (BBU), a baseband pool BBU pool, a Wi-Fi access point (AP), a central unit (CU) and a distributed unit (DU) in a cloud radio access network (C-RAN) system, an integrated access and backhaul (IAB) node, a device that functions as a base station in device-to-device (D2D), vehicle-to-everything (V2X), machine-to-machine (M2M) communication, internet of things (IoT) communication, or an evolved communication system after 5G such as 6G, and the like.

In another possible implementation, the first apparatus and/or the second apparatus may be a terminal device or an apparatus that implements a function of a terminal device, or may be an apparatus that can support a terminal device in implementing the function, for example, a chip system, and the apparatus may be installed in the terminal device. The terminal device mentioned in this embodiment of this application may be a device having a wireless sending and receiving function, and may be user equipment (UE), an access terminal, a subscriber unit, a subscriber station, a mobile station, a remote station, a remote terminal, a mobile device, a user terminal, a wireless communication device, a user agent, or a user apparatus. Alternatively, the terminal device may be a satellite phone, a cellular phone, a smartphone, a wireless data card, a wireless modem, a machine-type communication device, a cordless phone, a session initiation protocol (SIP) phone, a wireless local loop (WLL) station, a personal digital assistant (PDA), a handheld device having a wireless communication function, a computing device or another processing device connected to a wireless modem, a vehicle-mounted device, a communication device carried on a high-altitude aircraft, a wearable device, an unmanned aerial vehicle, a robot, a terminal in D2D, a terminal in V2X, a virtual reality (VR) terminal device, an augmented reality (AR) terminal device, a wireless terminal in industrial control, a wireless terminal in self driving, a wireless terminal in telemedicine (remote medical), a wireless terminal in a smart grid, a wireless terminal in transportation safety, a wireless terminal in a smart city, a wireless terminal in a smart home, a terminal device in a future communication network, or the like. This is not limited in this application.

The first apparatus and the second apparatus may be two apparatuses in multi-hop transmission. Generally, in multi-hop transmission, at least one source apparatus, at least one target apparatus, and at least one relay apparatus are included. Multi-hop transmission means that data is not directly transmitted from a source apparatus to a target apparatus, but is forwarded by a plurality of relay apparatuses between the source apparatus and the target apparatus. In other words, the data is forwarded by one or more relay apparatuses on a link. The source apparatus is configured to transmit data to the target apparatus, and is the 1^{st} apparatus that sends the data in the multi-hop transmission. The target apparatus is configured to receive the data from the source apparatus, and is the last apparatus that receives the data in the multi-hop transmission. The relay apparatus is configured to assist the source apparatus in forwarding the data to the target apparatus, and is an intermediate node between the source apparatus and the target apparatus. In addition, the source apparatus may also receive data sent by the target apparatus, and the relay apparatus may also be configured to assist the target apparatus in forwarding the data to the source apparatus.

FIG. 2 is used as an example. FIG. 2 shows a manner of three-hop transmission. An apparatus 1 serves as a source apparatus, an apparatus 4 is a target apparatus, and both an apparatus 2 and an apparatus 3 are relay apparatuses. The apparatus 1 sends data to the apparatus 2, the apparatus 2 forwards the data to the apparatus 3 after receiving the data, and the apparatus 3 forwards the data to the apparatus 4 after receiving the data.

In multi-hop transmission, one-hop transmission indicates one transmission process of data, a 1^{st} hop indicates 1^{st} transmission of the data, and a 2^{nd} hop indicates 2^{nd} transmission of the data. M-hop transmission is used as an example. In the M-hop transmission, M+1 apparatuses are included. During data transmission, data passes through the M+1 apparatuses in sequence. An i^{th} apparatus may be understood as an i^{th} apparatus that obtains the data. Correspondingly, a 1^{st} hop indicates that a 1^{st} apparatus sends data to a 2^{nd} apparatus, a 2^{nd} hop indicates that the 2^{nd} apparatus sends the data to a 3^{rd} apparatus, and correspondingly, an i^{th} hop indicates that an i^{th} apparatus sends the data to an (i+1)^{th} apparatus.

Based on the communication system described above, a technical background of embodiments of this application is mainly described below.

With large-scale popularization of Internet applications and wireless network devices, people's requirements for wireless communication gradually increase. To improve communication coverage, a relay apparatus is introduced at present to support multi-hop transmission from a source apparatus to a target apparatus. However, when the relay apparatus forwards data, a time-domain resource corresponding to each hop is separately indicated. The three-hop transmission described above is used as an example. A network device generates three pieces of corresponding indication information based on the three-hop transmission. One piece of indication information corresponds to one-hop transmission. For example, the three pieces of generated indication information include indication information 1, indication information 2, and indication information 3. The indication information 1 indicates a time-domain resource required for the source apparatus to send data to a first relay apparatus, the indication information 2 indicates a time-domain resource required for the first relay apparatus to send the data to a second relay apparatus, and the indication information 3 indicates a time-domain resource required for the second relay apparatus to send the data to the target apparatus. However, such a processing manner causes high overheads. How to reduce overheads is an urgent problem to be resolved.

To reduce overheads, an embodiment of this application provides a resource indication manner. This solution may be mainly applied to fields such as D2D, V2V, IAB, unmanned aerial vehicle (UAV), intelligent factory, and automated machine manufacturing, and may be further applied to another field. An application field to which this technical solution is applicable is not limited in embodiments of this application.

FIG. 3 is an interaction diagram of a resource indication method according to an embodiment of this application. As shown in FIG. 3, the network switching method includes operation 301 and operation 302. The method shown in FIG. 3 may be executed by a first apparatus and a second apparatus. Alternatively, the method shown in FIG. 3 may be executed by chips in the first apparatus and the second apparatus. In FIG. 3, the first apparatus and the second apparatus are used as an example for description. Execution bodies of a subsequent diagram follow the same principle. Details are not described subsequently.

301: The first apparatus obtains indication information, where the indication information indicates a configuration of time-domain resources for M-hop transmission between the first apparatus and a target apparatus, the M-hop transmission includes transmission between the first apparatus and the second apparatus, the indication information includes first information, the first information indicates a configuration of at least two time-domain resources, the at least two time-domain resources belong to a time-domain transmission resource and/or a time-domain reserved resource for the M-hop transmission, and M is an integer greater than 1.

In this embodiment of this application, the M-hop transmission between the first apparatus and the target apparatus means that when the first apparatus transmits data to the target apparatus, the data further needs to be forwarded by M−1 relay apparatuses before the data can be transmitted to the target apparatus.

The M-hop transmission between the first apparatus and the target apparatus belongs to K-hop transmission between a source apparatus and the target apparatus, where K is an integer greater than or equal to M. Based on the foregoing descriptions of the multi-hop transmission, the K-hop transmission between the source apparatus and the target apparatus means that when the source apparatus transmits data to the target apparatus, the data further needs to be forwarded by K−1 relay apparatuses before the data can be transmitted to the target apparatus. The source apparatus is configured to transmit data to the target apparatus, and is the 1^{st} apparatus that sends the data in the multi-hop transmission. The target apparatus is configured to receive the data from the source apparatus, and is the last apparatus that receives the data in the multi-hop transmission. The relay apparatus is configured to assist the source apparatus in forwarding the data to the target apparatus, and is an intermediate node between the source apparatus and the target apparatus. In addition, the source apparatus may also receive data sent by the target apparatus, and the relay apparatus may also be configured to assist the target apparatus in forwarding the data to the source apparatus. This is not limited in embodiments of this application. In subsequent descriptions in embodiments of this application, the source apparatus serves as a transmit end of data and the target apparatus serves as a receive end of data. A solution in which the source apparatus serves as a receive end and the target apparatus serves as a transmit end may be obtained in a similar way. Details are not described in embodiments of this application.

When K is greater than M, the first apparatus is a relay apparatus between the source apparatus and the target apparatus. When K is equal to M, the first apparatus is the source apparatus. The M-hop transmission includes the transmission between the first apparatus and the second apparatus. In an embodiment, the first apparatus and the second apparatus are two adjacent apparatuses in the M-hop transmission, and it may be understood that the transmission between the first apparatus and the second apparatus is one-hop transmission in the M-hop transmission. Alternatively, one or more relay apparatuses may be included between the first apparatus and the second apparatus, and it may be understood that the transmission between the first apparatus and the second apparatus is multi-hop transmission in the M-hop transmission. When the source apparatus serves as a transmit end and the target apparatus serves as a receive end, in the transmission between the first apparatus and the second apparatus, the first apparatus is a transmit end, and the second apparatus is a receive end.

In an embodiment, types of the first apparatus and the second apparatus include the following three cases: 1. Both the first apparatus and the second apparatus are relay apparatuses. 2. The first apparatus is the source apparatus, and the second apparatus is a relay apparatus. 3. The second apparatus is the target apparatus, and the first apparatus is a relay apparatus.

In this embodiment of this application, the indication information indicates the configuration of the time-domain resources for the M-hop transmission. In an embodiment, the indication information indicates a configuration of a time-domain transmission resource for each hop in the M-hop transmission. In an embodiment, if at least two adjacent apparatuses in the M-hop transmission are terminal devices, or there is a sidelink (SL) in the M-hop transmission, the indication information further indicates a configuration of a time-domain reserved resource corresponding to the hop. If an apparatus in the M hops is a network device, or there is a downlink (DL) in the M-hop transmission, a hop corresponding to the network device does not need a configuration of a time-domain reserved resource, and the indication information indicates a configuration of a transmission resource corresponding to the hop. A configuration of a time-domain transmission resource is a configuration of a time-domain resource required for current data transmission, and a configuration of a time-domain reserved resource is a configuration of a time-domain resource required and reserved for retransmission or transmission of other data.

The indication information includes the first information, the first information indicates the configuration of the at least two time-domain resources, and the at least two time-domain resources belong to a time-domain transmission resource and/or a time-domain reserved resource for the M-hop transmission. In an embodiment, the first information includes a plurality of state values, and one state value corresponds to one configuration of the at least two time-domain resources. It may be understood that the first information uses a manner in which the at least two time-domain resources are combined in one piece of information for indication. The state value may be understood as bit information. For example, it is assumed that a size configured for the first information is 2 bits. In this case, a state value in the first information may be one of the following four pieces of bit information: 00, 01, 10, and 11.

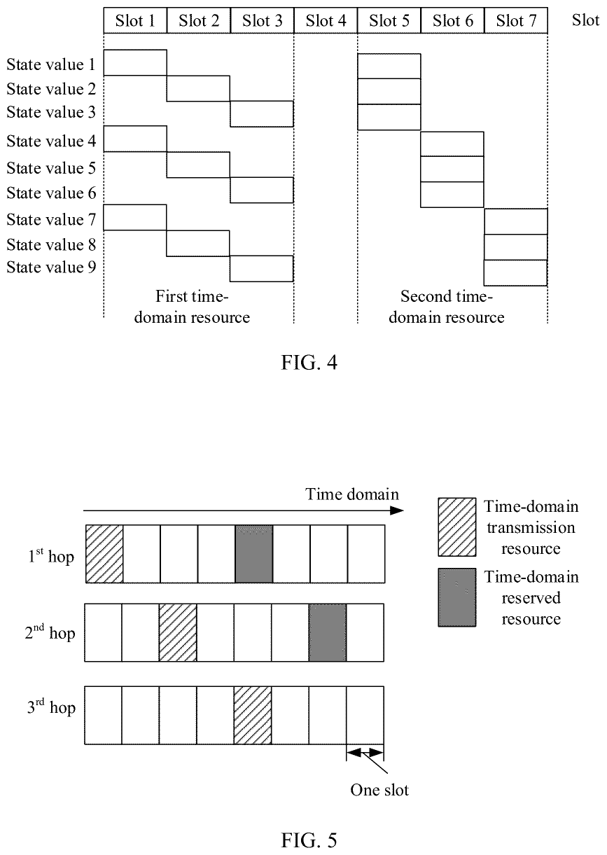

For example, as shown in FIG. 4, FIG. 4 includes two time-domain resources: a first time-domain resource and a second time-domain resource. The first time-domain resource corresponds to three configuration manners. In other words, the first time-domain resource is one of a slot 1, a slot 2, and a slot 3. The second time-domain resource also corresponds to three configuration manners. In other words, the second time-domain resource is one of a slot 5, a slot 6, and a slot 7. Nine configuration manners corresponding to a combination of the first time-domain resource and the second time-domain resource may be obtained by permuting the first time-domain resource and the second time-domain resource, and the nine configuration manners may correspond to nine state values of the first information respectively. For example, when a state value in the first information is 5, it may be determined that the first time-domain resource is the slot 2 and the second time-domain resource is the slot 6; or when a state value in the first information is 9, it may be determined that the first time-domain resource is the slot 3 and the second time-domain resource is the slot 7.

Because a size configured for indication information is limited, when a separate indication manner is used, that is, a manner in which one piece of resource indication information indicates a configuration of one time-domain resource is used, a quantity of state values included in a size configured for the resource indication information is greater than a quantity of configuration manners of the time-domain resource. For example, the size of the resource indication information is 2 bits, and corresponds to four state values. The resource indication information can indicate a maximum of four configuration manners. However, a current quantity of configuration manners of the time-domain resource is 3. Because 3 is less than 4, the quantity of state values corresponding to the size configured for the resource indication information is greater than the quantity of configuration manners of the time-domain resource. In addition, as a quantity of time-domain resources that need to be configured increases, higher overheads are caused, and more resources are wasted.

Because the first information indicates the configuration of the at least two time-domain resources, a quantity of state values required by the first information may be determined based on a quantity of configuration manners of the at least two time-domain resources. One state value corresponds to one configuration manner of the at least two time-domain resources. A more appropriate size is configured for the first information based on the quantity of state values required by the first information, to avoid higher overheads caused by a larger quantity of time-domain resources that need to be configured. Therefore, this can effectively reduce a waste of resources caused when a quantity of state values corresponding to a size configured for the first information is greater than a quantity of configurations of a plurality of time-domain resources, thereby effectively reducing time-domain resource indication overheads. For example, it is assumed that there are three different time-domain resources in this case, and each of the three different time-domain resources corresponds to three configuration manners. If a separate indication method is used, that is, three pieces of resource indication information are required, because one time-domain resource corresponds to three configuration manners, at least three indicative state values need to be configured for one piece of resource indication information. Therefore, a size configured for one piece of resource indication information is 2 bits, and the three pieces of resource indication information require a total of 6 bits. If the resource indication method described in this application is used, it is assumed that the first information indicates a configuration of three different time-domain resources and each of the three time-domain resources corresponds to three configuration manners, a combination of the three time-domain resources may correspond to 27 configuration manners, and at least 27 indicative state values need to be configured for the first information. Therefore, a size of the first information may be 5 bits, 32 state values are included, and all the 27 configuration manners can be indicated. A total of 6 bits are required in the separate indication method described above, and only 5 bits are required for the first information in the method described in this application. It can be learned that time-domain resource indication overheads can be effectively reduced by using the method described in this application.

With reference to the foregoing manner in which the first information indicates a configuration of at least two time-domain resources, in an embodiment, two time-domain resources indicated in the first information meet an end-to-end packet delay budget (PDB) requirement. The end-to-end PDB requirement is a maximum time interval required from a time at which the source apparatus starts to send data to a time at which the target apparatus receives the data. The two time-domain resources indicated in the first information meeting the end-to-end PDB requirement may be understood as follows: Time-domain positions corresponding to the two time-domain resources indicated in the first information are within a range of the maximum time interval required from the time at which the source apparatus starts to send the data to the time at which the target apparatus receives the data. In this implementation, a time-domain resource indicated in the first information may be configured based on the end-to-end PDB. FIG. 4 is used as an example. All time-domain resources that meet the end-to-end PDB may be first determined. In FIG. 4, all of a slot 1 to a slot 7 are slots that meet the end-to-end PDB. It is assumed that the first information indicates a configuration of a first time-domain resource and a second time-domain resource. Six slots may be selected from the slot 1 to the slot 7 as candidate time-domain resources to correspond to a plurality of configuration manners of the first time-domain resource and the second time-domain resource in the first information. The selected candidate resources may be indicated by using other signaling. For example, candidate resources corresponding to the first time-domain resource are the slot 1, the slot 2, and the slot 3, and candidate time-domain resources corresponding to the second time-domain resource are the slot 5, the slot 6, and the slot 7. If the first time-domain resource and the second time-domain resource need to occupy only one slot, configuration manners of the first time-domain resource and the second time-domain resource may be permuted based on selection of candidate resources, to obtain nine configuration manners corresponding to a combination of the first time-domain resource and the second time-domain resource. The nine configuration manners may correspond to nine state values of the first information respectively, and the first information may implement indication by using a state value.

In an embodiment, if it is assumed that a size configured for the first information is limited and it is impossible to indicate all configuration manners of the at least two time-domain resources in the first information, A configuration manners may be selected, to be indicated, from B configuration manners of the at least two time-domain resources based on the quantity A of state values corresponding to the size of the first information, where both A and B are integers, and A is less than B. FIG. 4 is used as an example. It can be learned that there are nine configuration manners of the first time-domain resource and the second time-domain resource indicated in the first information. If it is assumed that a size configured for the first information is 3 bits, the first information can indicate only eight state values. In this case, eight configuration manners need to be selected, to be indicated, from the nine configuration manners. For example, configuration manners corresponding to a state value 1 to a state value 8 in FIG. 4 may be selected to be indicated. This implementation helps reduce time-domain resource indication overheads.

In an embodiment, time-domain resources corresponding to the configuration of the at least two time-domain resources indicated in the first information do not overlap. In an embodiment, two time-domain resources not overlapping may be understood as follows: Start times of the two time-domain resources do not overlap. Alternatively, it may be understood as follows: The two time-domain resources do not overlap at all. Alternatively, it may be understood as follows: The two time-domain resources are orthogonal or time-division multiplexed. In a process of the M-hop transmission, a time-domain transmission resource and a time-domain reserved resource that are required for each hop need to be first determined. In each hop, a time corresponding to the time-domain transmission resource is earlier than a time corresponding to the time-domain reserved resource. In this case, there may be, for example, a situation in which a time-domain reserved resource for a 1^{st} hop overlaps a time-domain transmission resource for a 3^{rd} hop, causing ambiguous indication by the first information. For example, as shown in FIG. 5, FIG. 5 includes time-domain transmission resources and time-domain reserved resources required for three-hop transmission. It can be learned that a transmission resource for each hop occupies one slot, there is an interval of one slot between time-domain transmission resources for two adjacent hops, and there is an interval of three slots between a time-domain transmission resource and a time-domain reserved resource in a same hop. It can be learned from the figure that a time-domain reserved resource for a 1^{st} hop overlaps a time-domain transmission resource for a 3^{rd} hop. If the time-domain reserved resource for the 1^{st} hop and the time-domain transmission resource for the 3^{rd} hop are indicated by a same piece of resource indication information, a problem of ambiguous indication occurs. Therefore, time-domain resources corresponding to the configuration of the at least two time-domain resources indicated in the first information do not overlap, to help avoid a problem of ambiguous indication caused by overlapped indication of a time-domain transmission resource and a time-domain reserved resource for different hops.

In an embodiment, the indication information further includes second information, the second information indicates a configuration of at least two time-domain resources, the first information indicates a configuration of a first group of time-domain resources, and the second information indicates a configuration of a second group of time-domain resources. The first group of time-domain resources includes at least two time-domain resources required for the M-hop transmission, and the second group of time-domain resources includes at least two time-domain resources required for the M-hop transmission. In an embodiment, the at least two time-domain resources included in the first group of time-domain resources do not overlap each other. Similarly, the at least two time-domain resources included in the second group of time-domain resources do not overlap each other. According to this implementation, ambiguous resource indication can be avoided. Further, in an embodiment, because the first group of time-domain resources and the second group of time-domain resources are indicated by using different information, time-domain resources in the two groups may overlap, to improve resource utilization.

For example, it is assumed that the first group of time-domain resources includes a time-domain transmission resource and a time-domain reserved resource that are required for the transmission between the first apparatus and the second apparatus, and the second group of time-domain resources includes a time-domain transmission resource and a time-domain reserved resource that are required for transmission between the second apparatus and a third apparatus. The transmission between the second apparatus and the third apparatus is transmission in the M hops, and is next-hop transmission of the transmission between the first apparatus and the second apparatus. In this embodiment of this application, the reserved resource required for the transmission between the first apparatus and the second apparatus in the first group of time-domain resources may overlap the transmission resource required for the transmission between the second apparatus and the third apparatus in the second group of time-domain resources, to improve resource utilization. According to the implementation method, both the first information and the second information may indicate a configuration of a plurality of time-domain resources, to improve resource utilization.

In an embodiment, the indication information may alternatively include a plurality of pieces of resource indication information, each piece of resource indication information indicates a configuration of one group of time-domain resources for the M-hop transmission, and time-domain resources included in the configuration of the group of time-domain resources belong to a time-domain transmission resource and/or a time-domain reserved resource for the M-hop transmission. Both the first information and the second information described above belong to resource indication information. In an embodiment, time-domain resources in a same group of time-domain resources do not overlap, to help avoid ambiguous indication by resource indication information. In an embodiment, because different groups of time-domain resources correspond to different resource indication information, time-domain resources in the different groups may overlap, to help improve resource utilization.

Time-domain resources required for the M-hop transmission may be grouped based on the following plurality of bases: 1. Grouping is performed based on a hop count. For example, a time-domain transmission resource and a time-domain reserved resource for each hop in the M-hop transmission are grouped into one group. 2. Grouping is performed based on a type of a time-domain resource. For example, time-domain transmission resources for the M-hop transmission are grouped into one group, and time-domain reserved resources for the M-hop transmission are grouped into one group. 3. Grouping is performed based on whether a current factor is likely to be affected by a surrounding environment. For example, currently, the first apparatus and the second apparatus are about to perform data transmission, which is likely to be affected by another surrounding apparatus. In this case, a time-domain transmission resource and a time-domain reserved resource that are required for the transmission between the first apparatus and the second apparatus are grouped into one group, and a time-domain transmission resource and a time-domain reserved resource for (M−1)-hop transmission other than the transmission between the first apparatus and the second apparatus in the M-hop transmission are grouped into one or more groups. In addition to the foregoing content, another basis for grouping the time-domain resources required for the M-hop transmission may be included. This is not limited in embodiments of this application.

In an embodiment, the first information and the second information are carried on different channels. Further, in an embodiment, the first apparatus and the second apparatus are terminal devices or apparatuses that implement a function of a terminal device, and the indication information may be sidelink control signaling (SCI) or super sidelink control signaling (SSCI). The first information is carried on a control channel, and the second information is carried on a data channel. Further, in an embodiment, the first information is stage-1 (stage 1) SCI (or SSCI) in SCI (or SSCI), and the second information is stage-2 (stage 2) SCI (or SSCI). It should be additionally noted that the first information and the second information may alternatively be carried on different control channels. For example, the first information is carried on a first control channel, and the second information is carried on a second control channel. According to this manner, the configuration, of the time-domain resources, indicated by the first information can be read by another surrounding device. This helps prevent, in a contention-based resource allocation scenario, a surrounding and neighboring apparatus in a current hop from occupying a time-domain resource required for transmission. In addition, if the second information is transmitted on the data channel, resources on the control channel can be saved. The surrounding and neighboring apparatus in the current hop may be understood as an apparatus that is close to the first apparatus and the second apparatus and that contends for resources with the first apparatus and the second apparatus.

Alternatively, the first information and the second information may be carried on a same channel. This is not limited in embodiments of this application.

In an embodiment, the configuration of the first group of time-domain resources includes a configuration of a time-domain transmission resource and a configuration of a time-domain reserved resource between the first apparatus and the second apparatus; and the configuration of the second group of time-domain resources includes a configuration of a time-domain transmission resource and a configuration of a time-domain reserved resource for N-hop transmission, the N-hop transmission is N-hop transmission other than the transmission between the first apparatus and the second apparatus in the M-hop transmission, N is an integer greater than 1, and N is less than M.

The configuration of the time-domain transmission resource and the configuration of the time-domain reserved resource between the first apparatus and the second apparatus may be understood as a configuration of a time-domain transmission resource and a configuration of a time-domain reserved resource that are required for a 1^{st} hop in a process of the M-hop transmission. The configuration of the time-domain transmission resource and the configuration of the time-domain reserved resource for the N-hop transmission may be understood as a configuration of a time-domain transmission resource and a configuration of a time-domain reserved resource that are required for remaining hops other than the 1^{st} hop in the M-hop transmission. For example, it is assumed that M is 3. In this case, the configuration of the first group of time-domain resources includes a configuration of a time-domain transmission resource and a configuration of a time-domain reserved resource for a 1^{st} hop, that is, the configuration of the time-domain transmission resource and the configuration of the time-domain reserved resource for the transmission between the first apparatus and the second apparatus, and the configuration of the second group of time-domain resources includes a configuration of a time-domain transmission resource and a configuration of a time-domain reserved resource for a 2^{nd} hop, and a configuration of a time-domain transmission resource and a configuration of a time-domain reserved resource for a 3^{rd} hop.

In an embodiment, in addition to the first information and the second information, the indication information may include third information. The third information indicates a configuration of a third group of time-domain resources, and the configuration of the third group of time-domain resources includes a configuration of a time-domain transmission resource and a configuration of a time-domain reserved resource for P-hop transmission, which is P-hop transmission other than the transmission between the first apparatus and the second apparatus and the N-hop transmission in the M-hop transmission, where P+N is less than or equal to M−1. In an embodiment, a plurality of time-domain resources corresponding to the configuration of the second group of time-domain resources do not overlap each other, and a plurality of time-domain resources corresponding to the configuration of the third group of time-domain resources do not overlap each other. This method helps avoid ambiguous indication by the second information and the third information. In an embodiment, a time-domain resource corresponding to the configuration of the first group of time-domain resources, a time-domain resource corresponding to the configuration of the second group of time-domain resources, and a time-domain resource corresponding to the configuration of the third group of time-domain resources may overlap each other. This method helps improve resource utilization.

The indication information may alternatively include a plurality of pieces of resource indication information, and the resource indication information indicates a configuration of a time-domain transmission resource and a configuration of a time-domain reserved resource that are required for one or more hops in the M hops. This is not limited in embodiments of this application.

In an embodiment, with reference to the foregoing implementation in which the first information and the second information are carried on different channels, when the first information is carried on a control channel and the second information is carried on a data channel, a time of the first group of time-domain resources is earlier when time-domain resources that are required for the 1^{st} -hop transmission and that correspond to the configuration of the first group of time-domain resources are compared with time-domain resources that are required for the remaining-hop transmission and that correspond to the configuration of the second group of time-domain resources, and the shared control channel is used for transmission, so that a surrounding and neighboring apparatus in a current hop can perform reading in time. This helps prevent the neighboring apparatus from occupying a corresponding resource, and the neighboring apparatus may also configure a current resource and a future resource based on the first information, to avoid mutual interference. In addition, a relative time of the second group of time-domain resources indicated in the second information is later, and when a corresponding hop is farther from the current hop, mutual interference with the surrounding and neighboring apparatus in the current hop is less, or even may be ignored. The neighboring apparatus temporarily does not occupy a corresponding resource. The second information is transmitted on the data channel, so that resources on the control channel can be saved. In this embodiment of this application, based on degree of interference impact, a configuration of a resource for a hop that is likely to receive great interference is placed in stage-1 control information, and a configuration of a resource for another hop is placed in stage-2 control information. This helps prevent a surrounding and neighboring apparatus from occupying a resource required for a current hop, and can save resources on a control channel.

In an embodiment, the configuration of the first group of time-domain resources includes a configuration of a time-domain transmission resource for the M-hop transmission, and the configuration of the second group of time-domain resources includes a configuration of a time-domain reserved resource for the M-hop transmission. For example, it is assumed that M is 3. In this case, the configuration of the first group of time-domain resources includes a configuration of a time-domain transmission resource for a 1^{st} hop, a configuration of a time-domain transmission resource for a 2^{nd} hop, and a configuration of a time-domain transmission resource for a 3^{rd} hop. The configuration of the second group of time-domain resources includes a configuration of a time-domain reserved resource for the 1^{st} hop, a configuration of a time-domain reserved resource for the 2^{nd} hop, and a configuration of a time-domain reserved resource for the 3^{rd} hop.

In an embodiment, with reference to the foregoing implementation in which the first information and the second information are carried on different channels, when the first information is carried on a control channel and the second information is carried on a data channel, a time of the first group of time-domain resources is earlier when the configuration that is of the time-domain transmission resource for the M-hop transmission and that corresponds to the configuration of the first group of time-domain resources is compared with the configuration that is of the time-domain reserved resource for the M-hop transmission and that corresponds to the configuration of the second group of time-domain resources, and the shared control channel is used for transmission, so that a surrounding and neighboring apparatus in a current hop can perform reading in time. This helps prevent the surrounding and neighboring apparatus in the current hop from occupying a corresponding resource, and the neighboring apparatus may also configure a current resource and a future resource based on the first information, to avoid mutual interference. In addition, a relative time of the second group of time-domain resources indicated in the second information is later, and when a corresponding hop is farther from the current hop, mutual interference with the surrounding and neighboring apparatus in the current hop is less, or even may be ignored. The neighboring apparatus temporarily does not occupy a corresponding resource. The second information is transmitted on the data channel, so that resources on the control channel can be saved. In this embodiment of this application, based on degree of interference impact, a configuration of a resource for a hop that is likely to receive great interference is placed in stage-1 control information, and a configuration of a resource for another hop is placed in stage-2 control information. This helps prevent a surrounding and neighboring apparatus from occupying a resource required for a current hop, and can save resources on a control channel.

In an embodiment, the indication information further includes third information, the third information indicates a configuration of at least two time-domain resources, and the third information indicates a configuration of a third group of time-domain resources; the configuration of the first group of time-domain resources includes a configuration of a time-domain transmission resource and a configuration of a time-domain reserved resource between the first apparatus and the second apparatus; the configuration of the second group of time-domain resources includes a configuration of a time-domain transmission resource for (M−1)-hop transmission, and the (M−1)-hop transmission is (M−1)-hop transmission other than the transmission between the first apparatus and the second apparatus in the M-hop transmission; and the configuration of the third group of time-domain resources includes a configuration of a time-domain reserved resource for the (M−1)-hop transmission. For example, it is assumed that M is 3. In this case, the configuration of the first group of time-domain resources includes a configuration of a time-domain transmission resource and a configuration of a time-domain reserved resource for a 1^{st} hop, the configuration of the second group of time-domain resources includes a configuration of a time-domain transmission resource for a 2^{nd} hop and a configuration of a time-domain transmission resource for a 3^{rd} hop, and the configuration of the third group of time-domain resources includes a configuration of a time-domain reserved resource for the 2^{nd} hop and a configuration of a time-domain reserved resource for the 3^{rd} hop.

In an embodiment, with reference to the foregoing implementation in which the first information and the second information are carried on different channels, when the first information is carried on a control channel, the second information is carried on a data channel, and the third information is carried on a data channel, a time of the first group of time-domain resources is earlier when a configuration that is of a time-domain transmission resource for the M-hop transmission and that corresponds to the configuration of the first group of time-domain resources is compared with configurations of the other two groups of time-domain resources, and the shared control channel is used, so that a neighboring apparatus in a current hop can perform reading in time. This helps prevent the neighboring apparatus in the current hop from occupying a corresponding resource, and the neighboring apparatus may also configure a current resource and a future resource based on the first information, to avoid mutual interference. In addition, relative times of the second group of time-domain resources indicated in the second information and the third group of time-domain resources indicated in the third information are later, and when a corresponding hop is farther from the current hop, mutual interference with the surrounding and neighboring apparatus in the current hop is less, or even may be ignored. The neighboring apparatus temporarily does not occupy a corresponding resource. The second information and the third information are transmitted on the data channel, so that resources on the control channel can be saved. In this embodiment of this application, based on degree of interference impact, a configuration of a resource for a hop that is likely to receive great interference is placed in stage-1 control information, and a configuration of a resource for another hop is placed in stage-2 control information. This helps prevent a surrounding and neighboring apparatus from occupying a resource required for a current hop, and can save resources on a control channel.

Alternatively, when both the first information and the second information are carried on a control channel and the third information is carried on a data channel, times of the first group of time-domain resources and the second group of time-domain resources are earlier, and the shared control channel is used, so that a neighboring apparatus in a current hop can perform reading in time. This helps prevent the surrounding and neighboring apparatus in the current hop from occupying a corresponding resource, and the neighboring apparatus may also configure a current resource and a future resource based on the first information, to avoid mutual interference. In addition, a relative time of the third group of time-domain resources indicated in the third information is later, and when a corresponding hop is farther from the current hop, mutual interference with the surrounding and neighboring apparatus in the current hop is less, or even may be ignored. The neighboring apparatus temporarily does not occupy a corresponding resource. The third information is transmitted on the data channel, so that resources on the control channel can be saved. In this embodiment of this application, based on degree of interference impact, a configuration of a resource for a hop that is likely to receive great interference is placed in stage-1 control information, and a configuration of a resource for another hop is placed in stage-2 control information. This helps prevent a surrounding and neighboring apparatus from occupying a resource required for a current hop, and can save resources on a control channel.

In an embodiment, the indication information includes M pieces of first information, and the first information indicates a configuration of a time-domain transmission resource and a configuration of a time-domain reserved resource for one-hop transmission in the M-hop transmission. For example, it is assumed that M is 3. In this case, the indication information includes three pieces of first information, and the three pieces of first information respectively indicate a configuration of a time-domain transmission resource and a configuration of a time-domain reserved resource for a 1^{st} hop, a configuration of a time-domain transmission resource and a configuration of a time-domain reserved resource for a 2^{nd} hop, and a configuration of a time-domain transmission resource and a configuration of a time-domain reserved resource for a 3^{rd} hop.

In an embodiment, in the M pieces of first information, first information indicating a configuration of a time-domain transmission resource and a configuration of a time-domain reserved resource for a 1^{st} hop may be carried on a control channel, and M−1 pieces of first information other than the first information indicating the configuration of the time-domain transmission resource and the configuration of the time-domain reserved resource for the 1^{st} hop in the M pieces of first information are carried on a data channel. A relative time of time-domain resources required for the 1^{st} hop is earlier, and the shared control channel is used, so that a surrounding and neighboring apparatus in a current hop can perform reading in time. The neighboring apparatus may also configure a current resource and a future resource based on the information, to avoid mutual interference. This helps prevent the surrounding and neighboring apparatus in the current hop from occupying a corresponding resource. In addition, time-domain resources indicated in the other M−1 pieces of first information are later, and when a corresponding hop is farther from the current hop, mutual interference with the surrounding and neighboring apparatus in the current hop is less, or even may be ignored. Therefore, the neighboring apparatus temporarily does not occupy a corresponding resource. Transmission is performed on the data channel, so that resources on the control channel can be saved. In this embodiment of this application, based on degree of interference impact, a configuration of a resource for a hop that is likely to receive great interference is placed in stage-1 control information, and a configuration of a resource for another hop is placed in stage-2 control information. This helps prevent a surrounding and neighboring apparatus from occupying a resource required for a current hop, and can save resources on a control channel.

In an embodiment, a manner of grouping the time-domain resources required for the M-hop transmission may be: first grouping time-domain transmission resources for the M hops according to a time sequence, and then grouping time-domain reserved resources for the M hops according to a time sequence. For example, it is assumed that M is 2 and a quantity of time-domain resources in each group is 2. The time-domain transmission resources for the M hops are first grouped according to a time sequence, and an obtained group is as follows: A first group of time-domain resources includes a time-domain transmission resource for a 1^{st} hop and a time-domain transmission resource for a 2^{nd} hop. After the time-domain transmission resources are grouped, the time-domain reserved resources for the M hops are grouped according to a time sequence, and an obtained group is as follows: A second group of time-domain resources includes a time-domain reserved resource for the 1^{st} hop and a time-domain reserved resource for the 2^{nd} hop.

Alternatively, a manner of grouping the time-domain resources required for the M-hop transmission may be: performing grouping based on a sequence of each hop in the M hops. For example, it is assumed that M is 2 and a quantity of time-domain resources in each group is 2. Grouping is performed based on a sequence of each hop in the M hops, and obtained groups are as follows: A first group of time-domain resources includes a time-domain transmission resource and a time-domain reserved resource for a 1^{st} hop, and a second group of time-domain resources includes a time-domain transmission resource and a time-domain reserved resource for a 2^{nd} hop.

In addition to the foregoing manners of grouping the time-domain resources required for the M-hop transmission, there may be another grouping manner. This is not limited in embodiments of this application.

In an embodiment, the indication information further includes fourth information, and the fourth information indicates a configuration of one time-domain resource. In an embodiment, the fourth information includes a plurality of state values, and one state value corresponds to one configuration of the time-domain resource. Correspondingly, the fourth information indicates the time-domain resource in a separate indication manner. In an embodiment, the fourth information indicates a time-domain transmission resource between the first apparatus and the second apparatus. Further, in an embodiment, the fourth information may be carried on a control channel for transmission. According to this manner, the separate indication method is used, so that a neighboring apparatus can read the fourth information more quickly when obtaining the information, to reduce an operation burden, and prevent the neighboring apparatus from occupying the time-domain transmission resource required for the transmission between the first apparatus and the second apparatus. The neighboring apparatus may also configure a current resource and a future resource based on the fourth information, to avoid mutual interference.

In an embodiment, implementations in which the first apparatus obtains the indication information may be the following two cases:
I. The first apparatus generates the indication information. In an embodiment, the first apparatus may be the source apparatus, and has a resource scheduling capability. The first apparatus may determine, by sensing a surrounding network environment, a configuration of time-domain resources for the M-hop transmission in the indication information.
II. The first apparatus receives target information sent by a third apparatus. The indication information is generated based on the target information.

In an embodiment, the first apparatus is the source apparatus and does not have a resource scheduling capability, and the third apparatus is a network device. The third apparatus may sense a network environment, allocate a configuration of time-domain resources for the M-hop transmission, and send the configuration of the time-domain resources to the first apparatus by using the target information. The first apparatus may generate the indication information based on the received target information.

In an embodiment, the first apparatus is a relay apparatus, the K-hop transmission between the source apparatus and the target apparatus includes transmission between the first apparatus and the third apparatus, the third apparatus is a transmit end, and the first apparatus is a receive end. The target information includes a configuration of time-domain resources for (M+1)-hop transmission between the third apparatus and the target apparatus. After receiving data based on the target information, the first apparatus may delete, from the target information, a configuration of a time-domain resource for the transmission between the first apparatus and the third apparatus, to generate the indication information.

In an embodiment, the first information indicates the configuration of the at least two time-domain resources, and may indicate start times of the at least two time-domain resources. In an embodiment, the at least two time-domain resources are larger than one time unit, and the time unit may be one slot or one subslot. A part that is of the time-domain resource and that exceeds one time unit may be configured by using other signaling.

302: The first apparatus sends the indication information to the second apparatus. Correspondingly, the second apparatus receives the indication information sent by the first apparatus.

In this embodiment of this application, after the second apparatus receives the indication information, the second apparatus may receive, based on a configuration, indicated by the indication information, of a time-domain transmission resource between the first apparatus and the second apparatus in the M-hop transmission, data sent by the first apparatus. In an embodiment, a manner in which the first apparatus forwards data to the second apparatus may be decoding and forwarding (decode and forward, DF) based on a layer 1 (layer 1, L1) or amplification and forwarding (amplify and forward, AF) based on a layer 0 (layer 0, L0).

In an embodiment, the second apparatus is a relay apparatus. After receiving data based on the indication information, the second apparatus may delete, from the indication information, a configuration of a time-domain resource required for the transmission between the first apparatus and the second apparatus, to generate new indication information, and send the new indication information to a fourth apparatus. The fourth apparatus is an apparatus adjacent to the second apparatus, and the M-hop transmission includes transmission between the second apparatus and the fourth apparatus.

To implement functions in the method provided in the foregoing embodiments of this application, both the first apparatus and the second apparatus may include a hardware structure and/or a software module, to implement the foregoing functions in a form of the hardware structure, the software module, or a combination of the hardware structure and the software module. Whether a function in the foregoing functions is performed by using the hardware structure, the software module, or the combination of the hardware structure and the software module depends on particular applications and design constraints of the technical solutions.

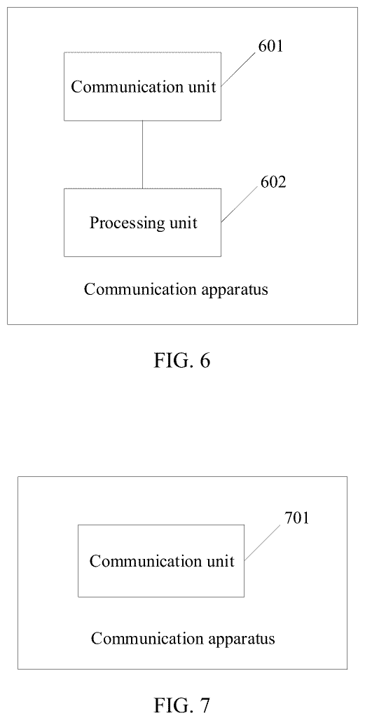

FIG. 6 is a diagram of a structure of a communication apparatus according to an embodiment of this application. The communication apparatus may be a first apparatus. In an embodiment, the communication apparatus may include modules or units that are in a one-to-one correspondence with the methods/operations/steps/actions performed by the first apparatus in the foregoing method embodiments. The units may be implemented by a hardware circuit, software, or a combination of a hardware circuit and software.

The communication apparatus shown in FIG. 6 may be a first apparatus or an apparatus that can be used in a matching manner with a first apparatus. The communication apparatus may alternatively be a chip system. The apparatus may be configured to perform some or all functions of the first apparatus in the method embodiments described in FIG. 3. The communication apparatus shown in FIG. 6 may include a communication unit 601 and a processing unit 602. The processing unit 602 is configured to perform data processing. A receiving unit and a sending unit are integrated into the communication unit 601. The communication unit 601 may also be referred to as a transceiver unit. Alternatively, the communication unit 601 may be split into a receiving unit and a sending unit.

The processing unit 602 is configured to obtain indication information, where the indication information indicates a configuration of time-domain resources for M-hop transmission between a first apparatus and a target apparatus, the M-hop transmission includes transmission between the first apparatus and a second apparatus, the indication information includes first information, the first information indicates a configuration of at least two time-domain resources, the at least two time-domain resources belong to a time-domain transmission resource and/or a time-domain reserved resource for the M-hop transmission, and M is an integer greater than 1. The communication unit 601 is configured to send the indication information to the second apparatus.

In an embodiment, time-domain resources corresponding to the configuration of the at least two time-domain resources do not overlap.

In an embodiment, the indication information further includes second information, the second information indicates a configuration of at least two time-domain resources, the first information indicates a configuration of a first group of time-domain resources, and the second information indicates a configuration of a second group of time-domain resources.

In an embodiment, the first information and the second information are carried on different channels.

In an embodiment, the configuration of the first group of time-domain resources includes a configuration of a time-domain transmission resource and a configuration of a time-domain reserved resource between the first apparatus and the second apparatus; and the configuration of the second group of time-domain resources includes a configuration of a time-domain transmission resource and a configuration of a time-domain reserved resource for N-hop transmission, the N-hop transmission is N-hop transmission other than the transmission between the first apparatus and the second apparatus in the M-hop transmission, N is an integer greater than 1, and N is less than M.

In an embodiment, the indication information further includes third information, the third information indicates a configuration of at least two time-domain resources, and the third information indicates a configuration of a third group of time-domain resources; the configuration of the first group of time-domain resources includes a configuration of a time-domain transmission resource and a configuration of a time-domain reserved resource between the first apparatus and the second apparatus; the configuration of the second group of time-domain resources includes a configuration of a time-domain transmission resource for (M−1)-hop transmission, and the (M−1)-hop transmission is (M−1)-hop transmission other than the transmission between the first apparatus and the second apparatus in the M-hop transmission; and the configuration of the third group of time-domain resources includes a configuration of a time-domain reserved resource for the (M−1)-hop transmission.

In an embodiment, the configuration of the first group of time-domain resources includes a configuration of a time-domain transmission resource for the M-hop transmission, and the configuration of the second group of time-domain resources includes a configuration of a time-domain reserved resource for the M-hop transmission.

In an embodiment, the indication information includes M pieces of first information, and the first information indicates a configuration of a time-domain transmission resource and a configuration of a time-domain reserved resource for one-hop transmission in the M-hop transmission.

In an embodiment, the indication information further includes fourth information, and the fourth information indicates a configuration of one time-domain resource.

FIG. 7 is a diagram of a structure of a communication apparatus according to an embodiment of this application. The communication apparatus may be a second apparatus. In an embodiment, the communication apparatus may include modules or units that are in a one-to-one correspondence with the methods/operations/steps/actions performed by the second apparatus in the foregoing method embodiments. The units may be implemented by a hardware circuit, software, or a combination of a hardware circuit and software.

The communication apparatus shown in FIG. 7 may be a second apparatus or an apparatus that can be used in a matching manner with a second apparatus. The communication apparatus may alternatively be a chip system. The apparatus may be configured to perform some or all functions of the second apparatus in the method embodiments described in FIG. 3. The communication apparatus shown in FIG. 7 may include a communication unit 701. A receiving unit and a sending unit are integrated into the communication unit 701. The communication unit 701 may also be referred to as a transceiver unit. Alternatively, the communication unit 701 may be split into a receiving unit and a sending unit.

The communication unit 701 is configured to receive indication information from a first apparatus, where the indication information indicates a configuration of time-domain resources for M-hop transmission between the first apparatus and a target apparatus, the M-hop transmission includes transmission between the first apparatus and a second apparatus, the indication information includes first information, the first information indicates a configuration of at least two time-domain resources, the at least two time-domain resources belong to a time-domain transmission resource and/or a time-domain reserved resource for the M-hop transmission, and M is an integer greater than 1. The communication unit 701 is further configured to receive data from the first apparatus based on the indication information.

In an embodiment, time-domain resources corresponding to the configuration of the at least two time-domain resources do not overlap.

In an embodiment, the indication information further includes second information, the second information indicates a configuration of at least two time-domain resources, the first information indicates a configuration of a first group of time-domain resources, and the second information indicates a configuration of a second group of time-domain resources.

In an embodiment, the first information and the second information are carried on different channels.

In an embodiment, the configuration of the first group of time-domain resources includes a configuration of a time-domain transmission resource and a configuration of a time-domain reserved resource between the first apparatus and the second apparatus; and the configuration of the second group of time-domain resources includes a configuration of a time-domain transmission resource and a configuration of a time-domain reserved resource for N-hop transmission, the N-hop transmission is N-hop transmission other than the transmission between the first apparatus and the second apparatus in the M-hop transmission, N is an integer greater than 1, and N is less than M.

In an embodiment, the indication information further includes third information, the third information indicates a configuration of at least two time-domain resources, and the third information indicates a configuration of a third group of time-domain resources; the configuration of the first group of time-domain resources includes a configuration of a time-domain transmission resource and a configuration of a time-domain reserved resource between the first apparatus and the second apparatus; the configuration of the second group of time-domain resources includes a configuration of a time-domain transmission resource for (M−1)-hop transmission, and the (M−1)-hop transmission is (M−1)-hop transmission other than the transmission between the first apparatus and the second apparatus in the M-hop transmission; and the configuration of the third group of time-domain resources includes a configuration of a time-domain reserved resource for the (M−1)-hop transmission.

In an embodiment, the configuration of the first group of time-domain resources includes a configuration of a time-domain transmission resource for the M-hop transmission, and the configuration of the second group of time-domain resources includes a configuration of a time-domain reserved resource for the M-hop transmission.

In an embodiment, the indication information includes M pieces of first information, and the first information indicates a configuration of a time-domain transmission resource and a configuration of a time-domain reserved resource for one-hop transmission in the M-hop transmission.

In an embodiment, the indication information further includes fourth information, and the fourth information indicates a configuration of one time-domain resource.

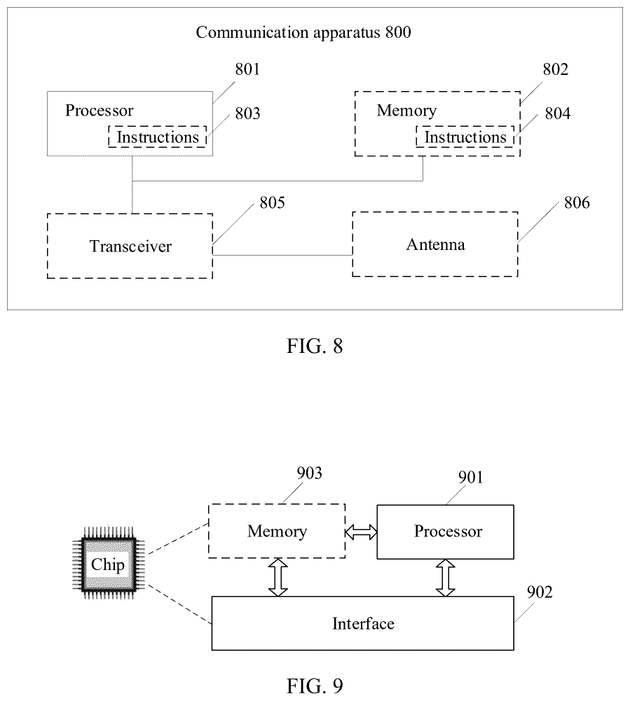

FIG. 8 is a diagram of a structure of a communication apparatus. The communication apparatus 800 may be the first apparatus in the foregoing method embodiments, or may be a chip, a chip system, a processor, or the like that supports the first apparatus in implementing the foregoing method. The communication apparatus may be configured to implement the method described in the foregoing method embodiments. For details, refer to the descriptions in the foregoing method embodiments.

Alternatively, the communication apparatus 800 may be the second apparatus in the foregoing method embodiments, or may be a chip, a chip system, a processor, or the like that supports the second apparatus in implementing the foregoing method. The communication apparatus may be configured to implement the method described in the foregoing method embodiments. For details, refer to the descriptions in the foregoing method embodiments.

The communication apparatus 800 may include one or more processors 801. The processor 801 may be a general-purpose processor, a dedicated processor, or the like. For example, the processor may be a baseband processor or a central processing unit. The baseband processor may be configured to process a communication protocol and communication data. The central processing unit may be configured to: control a communication apparatus (for example, a base station, a baseband chip, a terminal, a terminal chip, a DU, or a CU), execute a software program, and process data of the software program.

In an embodiment, the communication apparatus 800 may include one or more memories 802. The memory may store instructions 804, and the instructions may be run on the processor 801, to enable the communication apparatus 800 to perform the method described in the foregoing method embodiments. In an embodiment, the memory 802 may further store data. The processor 801 and the memory 802 may be disposed separately, or may be integrated together.

In an embodiment, the communication apparatus 800 may further include a transceiver 805 and an antenna 806. The transceiver 805 may be referred to as a transceiver unit, a transceiver machine, a transceiver circuit, or the like, and is configured to implement a sending and receiving function. The transceiver 805 may include a receiver and a transmitter. The receiver may be referred to as a receiver machine, a receiver circuit, or the like, and is configured to implement a receiving function. The transmitter may be referred to as a transmitter machine, a transmitter circuit, or the like, and is configured to implement a sending function.

The communication apparatus 800 is the first apparatus, and the processor 801 is configured to perform a data processing operation of the first apparatus in the foregoing method embodiments. The transceiver 805 is configured to perform a data sending and receiving operation of the first apparatus in the foregoing method embodiments.

Alternatively, the communication apparatus 800 is the second apparatus, and the processor 801 is configured to perform a data processing operation of the second apparatus in the foregoing method embodiments. The transceiver 805 is configured to perform a data sending and receiving operation of the second apparatus in the foregoing method embodiments.

In another possible design, the processor 801 may include a transceiver configured to implement receiving and sending functions. For example, the transceiver may be a transceiver circuit, an interface, or an interface circuit. The transceiver circuit, the interface, or the interface circuit configured to implement the receiving and sending functions may be separated, or may be integrated together. The transceiver circuit, the interface, or the interface circuit may be configured to read and write code/data. Alternatively, the transceiver circuit, the interface, or the interface circuit may be configured to transmit or transfer a signal.

In still another embodiment, the processor 801 may store instructions 803, and the instructions 803 are run on the processor 801, to enable the communication apparatus 800 to perform the method described in the foregoing method embodiments. The instructions 803 may be built into the processor 801. In this case, the processor 801 may be implemented by using hardware.

In still another possible design, the communication apparatus 800 may include a circuit. The circuit may implement a sending, receiving, or communication function in the foregoing method embodiments. The processor and the transceiver described in this embodiment of this application may be implemented on an integrated circuit (IC), an analog IC, a radio frequency integrated circuit (RFIC), a mixed-signal IC, an application-specific integrated circuit (ASIC), a printed circuit board (PCB), an electronic device, or the like.

The communication apparatus described in the foregoing embodiments may be a first apparatus or a second apparatus. However, a scope of the communication apparatus described in embodiments of this application is not limited thereto, and a structure of the communication apparatus may not be limited by FIG. 8. The communication apparatus may be an independent device or may be a part of a large device. For example, the communication apparatus may be:
(1) an independent integrated circuit IC, a chip, or a chip system or subsystem;
(2) a set including one or more ICs, where, the IC set may further include a storage component configured to store data or instructions;
(3) an ASIC, for example, a modem (MSM);
(4) a module that can be embedded in another device;
(5) a receiver, a terminal, an intelligent terminal, a cellular phone, a wireless device, a handheld device, a mobile unit, a vehicle-mounted device, a network device, a cloud device, an artificial intelligence device, or the like; or
(6) others.

For a case in which the communication apparatus may be a chip or a chip system, refer to a diagram of a structure of a chip shown in FIG. 9. The chip shown in FIG. 9 includes a processor 901 and an interface 902. In an embodiment, the chip may further include a memory 903. There may be one or more processors 901 and a plurality of interfaces 902.

In an embodiment, when the chip is configured to implement a function of the terminal device in embodiments of this application:
the interface 902 is configured to input or output a signal, and
the processor 901 is configured to perform a data processing operation of the terminal device in the foregoing method embodiments.

In another design, when the chip is configured to implement a function of the network device in embodiments of this application:
the interface 902 is configured to input or output a signal, and
the processor 901 is configured to perform a data processing operation of the network device in the foregoing method embodiments.

It may be understood that, in some scenarios, some optional features in embodiments of this application may be independently implemented without depending on another feature, for example, a solution on which the optional features currently are based, to resolve a corresponding technical problem and achieve a corresponding effect. Alternatively, in some scenarios, the optional features may be combined with another feature according to a requirement. Correspondingly, the communication apparatus provided in embodiments of this application may also correspondingly implement these features or functions. Details are not described herein.

It should be understood that the processor in embodiments of this application may be an integrated circuit chip, and has a signal processing capability. In an embodiment, operations of the foregoing method embodiments may be completed by using a hardware integrated logic circuit in the processor, or by using instructions in a form of software. The processor may be a general-purpose processor, a digital signal processor (DSP), an ASIC, a field programmable gate array (FPGA) or another programmable logic device, a discrete gate or a transistor logic device, or a discrete hardware component.

It may be understood that the memory in embodiments of this application may be a volatile memory or a nonvolatile memory, or may include both a volatile memory and a nonvolatile memory. The nonvolatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), used as an external cache. Through example but not limitative description, many forms of RAMs may be used, for example, a static random access memory (SRAM), a dynamic random access memory (DRAM), a synchronous dynamic random access memory (SDRAM), a double data rate synchronous dynamic random access memory (DDR SDRAM), an enhanced synchronous dynamic random access memory (ESDRAM), a synchlink dynamic random access memory (SLDRAM), and a direct rambus random access memory (DR RAM). It should be noted that the memory in the system and method described in the specification includes but is not limited to these and any memory of another proper type.

This application further provides a non-transitory computer-readable medium, configured to store computer software instructions. When the instructions are executed by a communication apparatus, a function in any one of the foregoing method embodiments is implemented.

This application further provides a computer program product, configured to store computer software instructions. When the instructions are executed by a communication apparatus, a function in any one of the foregoing method embodiments is implemented.

All or some of the foregoing embodiments may be implemented by using software, hardware, firmware, or any combination thereof. When software is used to implement the embodiments, all or some of the embodiments may be implemented in a form of computer program product. The computer program product includes one or more computer instructions. When the computer instructions are loaded and executed on a computer, all or some of the procedures or functions according to embodiments of this application are generated. The computer may be a general-purpose computer, a dedicated computer, a computer network, or another programmable apparatus. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by the computer, or a data storage device, for example, a server or a data center, integrating one or more usable media. The usable medium may be a magnetic medium (for example, a floppy disk, a hard disk, or a magnetic tape), an optical medium (for example, a high-density digital video disc (DVD)), a semiconductor medium (for example, a solid-state drive (SSD)), or the like.

In the foregoing embodiments, the descriptions of embodiments have respective focuses. For a part that is not described in detail in an embodiment, refer to related descriptions in other embodiments.

Finally, it should be noted that the foregoing embodiments are merely intended to describe the technical solutions of this application, but are not intended to limit this application. Although this application is described in detail with reference to the foregoing embodiments, a person of ordinary skill in the art should understand that modifications may still be made to the technical solutions described in the foregoing embodiments or equivalent replacements may still be made to some or all technical features thereof, without departing from the scope of the technical solutions in embodiments of this application.

1. A method of resource indication for a first apparatus, comprising:
obtaining indication information that indicates a configuration of time-domain resources for M-hop transmission between the first apparatus and a target apparatus, wherein the M-hop transmission comprises a transmission between the first apparatus and a second apparatus, the indication information comprises first information indicating a first configuration of at least two time-domain resources that belong to a time-domain transmission resource or a time-domain reserved resource for the M-hop transmission, and M is an integer greater than 1; and
sending the indication information to the second apparatus.

2. The method according to claim 1, wherein time-domain resources corresponding to the first configuration of the at least two time-domain resources do not overlap.

3. The method according to claim 1, wherein
the indication information further comprises second information indicating a second configuration of at least two time-domain resources;
the first configuration of at least two time-domain resources comprises a configuration of a first group of time-domain resources; and
the second configuration of at least two time-domain resources comprises a configuration of a second group of time-domain resources.

4. The method according to claim 3, wherein the first information and the second information are carried in different channels.

5. The method according to claim 3, wherein
the configuration of the first group of time-domain resources comprises a configuration of a time-domain transmission resource and a configuration of a time-domain reserved resource between the first apparatus and the second apparatus; and
the configuration of the second group of time-domain resources comprises a configuration of a time-domain transmission resource and a configuration of a time-domain reserved resource for N-hop transmission that is N-hop transmission other than the transmission between the first apparatus and the second apparatus of the M-hop transmission, N is an integer greater than 1 and less than M.

6. The method according to claim 3, wherein
the indication information further comprises third information indicating a third configuration of at least two time-domain resources, and the third configuration of at least two time-domain resources comprises a configuration of a third group of time-domain resources;
the configuration of the first group of time-domain resources comprises a configuration of a time-domain transmission resource and a configuration of a time-domain reserved resource between the first apparatus and the second apparatus;
the configuration of the second group of time-domain resources comprises a configuration of a time-domain transmission resource for (M−1)-hop transmission that is (M−1)-hop transmission other than the transmission between the first apparatus and the second apparatus of the M-hop transmission; and
the configuration of the third group of time-domain resources comprises a configuration of a time-domain reserved resource for the (M−1)-hop transmission.

7. The method according to claim 3, wherein
the configuration of the first group of time-domain resources comprises a configuration of a time-domain transmission resource for the M-hop transmission; and
the configuration of the second group of time-domain resources comprises a configuration of a time-domain reserved resource for the M-hop transmission.

8. The method according to claim 1, wherein the indication information comprises M pieces of the first information, and the first configuration of at least two time-domain resources comprises a configuration of a time-domain transmission resource and a configuration of a time-domain reserved resource for one-hop transmission in the M-hop transmission.

9. The method according to claim 1, wherein the indication information further comprises fourth information indicating a configuration of a time-domain resource.

10. A communication apparatus, comprising:
a processing unit configured to obtain indication information that indicates a configuration of time-domain resources for M-hop transmission between a first apparatus and a target apparatus, wherein the M-hop transmission comprises a transmission between the first apparatus and a second apparatus, the indication information comprises first information indicating a configuration of at least two time-domain resources that belong to a time-domain transmission resource or a time-domain reserved resource for the M-hop transmission, and M is an integer greater than 1; and
a communication unit configured to send the indication information to the second apparatus.

11. A communication apparatus, comprising:
at least one processor; and
a memory coupled to the at least one processor and storing instructions, which when executed by the at least one processor, cause the communication apparatus to:
receive indication information from a first apparatus, wherein the indication information indicates a configuration of time-domain resources for M-hop transmission between the first apparatus and a target apparatus, the M-hop transmission comprises a transmission between the first apparatus and a second apparatus, the indication information comprises first information indicating a first configuration of at least two time-domain resources that belong to a time-domain transmission resource or a time-domain reserved resource for the M-hop transmission, and M is an integer greater than 1; and
receive data from the first apparatus based on the indication information.

12. The communication apparatus according to claim 11, wherein time-domain resources corresponding to the first configuration of the at least two time-domain resources do not overlap.

13. The communication apparatus according to claim 11, wherein
the indication information further comprises second information indicating a second configuration of at least two time-domain resources;
the first configuration of the at least two time-domain resources comprises a configuration of a first group of time-domain resources; and
the second configuration of the at least two time-domain resources comprises a configuration of a second group of time-domain resources.

14. The communication apparatus according to claim 13, wherein the first information and the second information are carried in different channels.

15. The communication apparatus according to claim 13, wherein
the configuration of the first group of time-domain resources comprises a configuration of a time-domain transmission resource and a configuration of a time-domain reserved resource between the first apparatus and the second apparatus; and
the configuration of the second group of time-domain resources comprises a configuration of a time-domain transmission resource and a configuration of a time-domain reserved resource for N-hop transmission that is N-hop transmission other than the transmission between the first apparatus and the second apparatus of the M-hop transmission, N is an integer greater than 1 and less than M.

16. The communication apparatus according to claim 13, wherein
the indication information further comprises third information indicating a third configuration of at least two time-domain resources, and the third configuration of at least two time-domain resources comprises a configuration of a third group of time-domain resources;
the configuration of the first group of time-domain resources comprises a configuration of a time-domain transmission resource and a configuration of a time-domain reserved resource between the first apparatus and the second apparatus;
the configuration of the second group of time-domain resources comprises a configuration of a time-domain transmission resource for (M−1)-hop transmission that is (M−1)-hop transmission other than the transmission between the first apparatus and the second apparatus of the M-hop transmission; and
the configuration of the third group of time-domain resources comprises a configuration of a time-domain reserved resource for the (M−1)-hop transmission.

17. The communication apparatus according to claim 13, wherein
the configuration of the first group of time-domain resources comprises a configuration of a time-domain transmission resource for the M-hop transmission; and
the configuration of the second group of time-domain resources comprises a configuration of a time-domain reserved resource for the M-hop transmission.

18. The communication apparatus according to claim 11, wherein the indication information comprises M pieces of the first information, and the first configuration of at least two time-domain resources comprises a configuration of a time-domain transmission resource and a configuration of a time-domain reserved resource for one-hop transmission in the M-hop transmission.

19. The communication apparatus according to claim 11, wherein the indication information further comprises fourth information indicating a configuration of a time-domain resource.
